(19) United States
(12) Patent Application Publication
(10) Pub. No.: US 2013/0069907 A1
(43) Pub. Date: Mar. 21, 2013

(54) PROJECTED CAPACITIVE TOUCH PANEL WITH ACCELERATED TOUCH RESPONSE TIME

(71) Applicant: Jane HSU, Gueishan Township (TW)

(72) Inventor: Jane HSU, Gueishan Township (TW)

(21) Appl. No.: 13/598,664

(22) Filed: Aug. 30, 2012

(30) Foreign Application Priority Data
Sep. 16, 2011 (TW) 100217381

(51) Int. Cl. G06F 3/045

(52) U.S. Cl. 345/174

(57) ABSTRACT

A projected capacitive touch panel has multiple first electrode strings and multiple second electrode strings parallelly and alternately formed on a substrate. Each first electrode string and each second electrode string respectively have multiple first sensing electrodes and multiple second sensing electrodes connected in series, and have a first end and a second end. A coupling capacitor is formed between each first sensing electrode and an adjacent second sensing electrode. The first sensing electrodes of each first electrode string progressively decrease in area from the first end to the second end while the second sensing electrodes of each second electrode string progressively decrease in area oppositely. Each first electrode string or each second electrode string or commonly connected with at least one adjacent first or second electrode string, thereby increasing the capacitance between adjacent sensing electrodes on edges of the substrate and accelerating a touch response time.

### BACKGROUND OF THE INVENTION

1. Field of the Invention

The present invention relates to a projected capacitive touch panel and more particularly to a projected capacitive touch panel with accelerated touch response time.

2. Description of the Related Art

With reference to FIG. 4, a conventional projected capacitive touch panel has multiple X-axis electrode strings 71 and multiple Y-axis electrode strings 72 formed on a substrate 70. The X-axis electrode strings 71 are parallelly aligned in the direction of X axis. Each X-axis electrode string 71 has a first leading wire 710 connected with one end of the X-axis electrode string 71 and connected to one of a set of connection pads mounted on one side of the substrate 70 along edges of the substrate 70. Each X-axis electrode string 71 has multiple X-axis electrodes 711 connected in series with a first connection wire 712 connected between each adjacent two of the X-axis electrodes 711. The Y-axis electrode strings 72 are parallelly aligned in the direction of Y axis. Each Y-axis electrode string 72 is perpendicularly crossed by the X-axis electrode strings 71 and has a second leading wire 720 connected to another one of the set of connection pads mounted on the side of the substrate 70 along edges of the substrate 70. Each Y-axis electrode string 72 has multiple Y-axis electrodes 721 connected in series with a second connection wire 722 connected between each adjacent two of the Y-axis electrodes 721. When the X-axis electrode strings 71 and the Y-axis electrode strings 72 are formed on an identical surface of the substrate 70, each first connection wire 712 between two corresponding X-axis electrodes 711 is also crossly connected one of the second connection wires 722 between two corresponding Y-axis electrodes 721. With reference to FIG. 5, to avoid a short circuit, a separation layer 713 is formed between one of the first connection wires 712 and a corresponding second connection wire 722 crossed by the first connection wire 712.

From the foregoing structure, the conventional projected capacitive touch panel has the X-axis electrodes 711 and the Y-axis electrodes 721 aligned in the form of a matrix. A capacitance is formed between each X-axis electrode 711 and adjacent one of the Y-axis electrodes 721. Once a finger touches the adjacent X-axis electrode 711 and the Y-axis electrode 721, the capacitance therebetween is changed and a signal is transmitted to a controller through the set of connection pads connected with corresponding first leading wire 710 and second leading wire 720 to analyze and identify where the finger touches.

Despite the multi-touch feature and extensive applications in high-end products, such as smart phones, the projected capacitive touch panels still have many problems unsolved as follows.

1. Unsatisfactory accuracy of touch detection on edges of the touch panel: As mentioned, the X-axis electrodes 711 and the Y-axis electrodes 721 of the conventional projected capacitive touch panel are aligned in the form of a matrix. Besides the capacitance formed between adjacent X-axis electrode 711 and Y-axis electrode 721, each of the X-axis electrodes 711, the Y-axis electrodes 721, the first connection wires 712 and the second connection wires 722 has its own impedance. Hence, the closer the X-axis electrode 711 or the Y-axis electrode 721 to a corresponding X-axis leading wire 710 or Y-axis leading wire 720, the smaller the impedance of the X-axis electrode 711 or the Y-axis electrode 721 is. On the contrary, the farther the X-axis electrode 711 or the Y-axis electrode 721 away from a corresponding X-axis leading wire 710 or Y-axis leading wire 720, the higher the impedance of the X-axis electrode 711 or the Y-axis electrode 721 is. The X-axis electrodes 711 and Y-axis electrodes 721 relatively remote to the first leading wires 710 and second leading wires 720 are located adjacent to corresponding edges of the touch panel. In view of the impedance accumulation, the accuracy of touch detection on edges of the touch panel is relatively unsatisfactory. Under the circumstance, it is less likely to manufacture oversized projected capacitive touch panels.

2. Slow touch response time: In view of the progressively decreasing impedances, the touch response time of the X-axis electrodes 711 and the Y-axis electrodes 721 near edges of the touch panel is slowed down and the efficiency of the controller in reading sensed data through the X-axis electrodes 711 and the Y-axis electrodes 721.

3. More complicated in production: When the X-axis electrode strings 71 and the Y-axis electrode strings 72 are formed on an identical surface of the substrate 70, an additional manufacturing process for separating the first connection wires 712 on each X-axis electrode string 71 from the corresponding second connection wires 722 of the second electrode strings 72, such as after forming an indium tin oxide (ITO) layer on the substrate 70 and etching to form the X-axis electrode strings 71, further forming the separation layer 713 on each first connection wire 712 and then forming the corresponding second connection wire 722 on the separation layer 713 so that a short circuit does not occur between the first connection wire 712 and the second connection wire 722. However, the manufacturing process adds the complexity of the manufacturing process for the conventional projected capacitive touch panel.

### SUMMARY OF THE INVENTION

An objective of the present invention is to provide a projected capacitive touch panel capable of adjusting impedance and capacitance of desired position on the touch panel, accelerating the touch response time and facilitating the manufacture of oversize touch panel through the means of adjusting the area of the sensing electrodes on edges of the touch panel and increasing the capacitance value between adjacent sensing electrodes on the edges of the touch panel.

To achieve the foregoing objective, the projected capacitive touch panel has a substrate, multiple first electrode strings and multiple second electrode strings.

The substrate has a surface.

The first electrode strings are parallelly formed on the surface of the substrate. Each first electrode string has multiple first sensing electrodes connected in series with one another and has a first end and a second end. The first sensing electrodes are elongated and slender and progressive decrease in area from the first end to the second end. The first electrode strings are evenly divided into groups. The first electrode strings in each group are adjacent to one another. The first ends of the first electrode strings in each group are commonly connected.

The second electrode strings are parallelly formed on the surface of the substrate. Each second electrode string has multiple second sensing electrodes connected in series with one another and has a first end and a second end. The first electrode strings and the second electrode strings are elongated and slender and are alternately arranged on the substrate. The second sensing electrodes progressive decrease in area from the second end to the first end. The second electrode strings are evenly divided into groups. The second electrode strings in each group are adjacent to one another. The second ends of the second electrode strings in each group are commonly connected.

In the foregoing projected capacitive touch panel, a coupling capacitor is formed between a first sensing electrode of each first electrode string and an adjacent second sensing electrode of a corresponding second electrode string. The first electrode strings and the second electrode strings are respectively evenly divided into groups. The first electrode strings or the second electrode strings in each group are commonly connected through common ends thereof to parallelly connect the coupling capacitors. The effect of parallel connection increase the capacitance value and thus speeds up the touch response time.

Given the first sensing electrodes of each first electrode string progressively decrease in area from the first end to the second end and the second sensing electrodes of each second electrode string progressively decrease in area from the second end to the first end, the impedance of each sensing electrode on an identical electrode string can be adjusted. Besides, as the first and second sensing electrodes of the first and second electrode strings progressively decrease in area along opposite directions, the sensing electrodes progressively increasing in area are adjacent to the sensing electrodes progressively decreasing in area. Hence, the difference values of the RC values of adjacent sensing electrodes are widened so as to enhance the accuracy of touch detection near edge and facilitate the manufacture of oversized touch panels.

Moreover, the first and second sensing electrodes on the first and second electrode strings are arranged in the form of a matrix, and the first and second electrode strings are parallelly and alternately aligned. In other words, the first and second electrode strings do not intersect at all. Accordingly, a manufacturing process for forming a separation layer can be eliminated to simplify the manufacturing processes of the projected capacitive touch panel. Other objectives, advantages and novel features of the invention will become more apparent from the following detailed description when taken in conjunction with the accompanying drawings.

### BRIEF DESCRIPTION OF THE DRAWINGS

FIG. 1 is a plane view of a projected capacitive touch panel in accordance with the present invention;

FIG. 2 is a partially enlarged plane view of the projected capacitive touch panel in FIG. 1;

FIG. 3 is another partially enlarged plane view of the projected capacitive touch panel in FIG. 1;

FIG. 4 is a plane view of a conventional projected capacitive touch panel; and

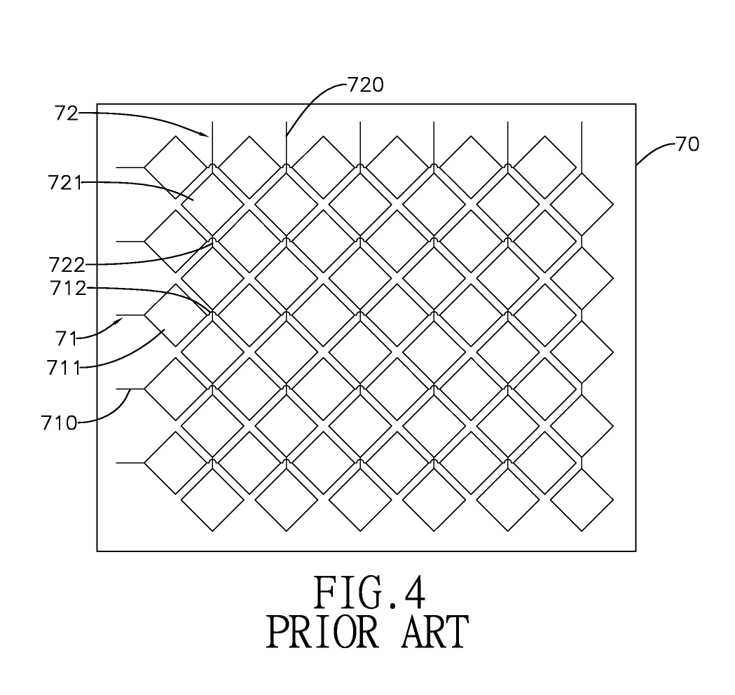

FIG. 5 is a side view in partial section of the conventional projected capacitive touch panel in FIG. 4.

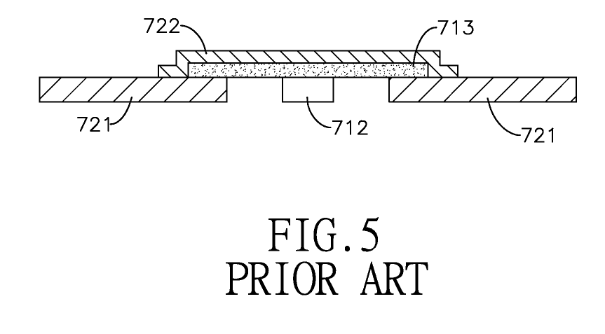

### DETAILED DESCRIPTION OF THE INVENTION

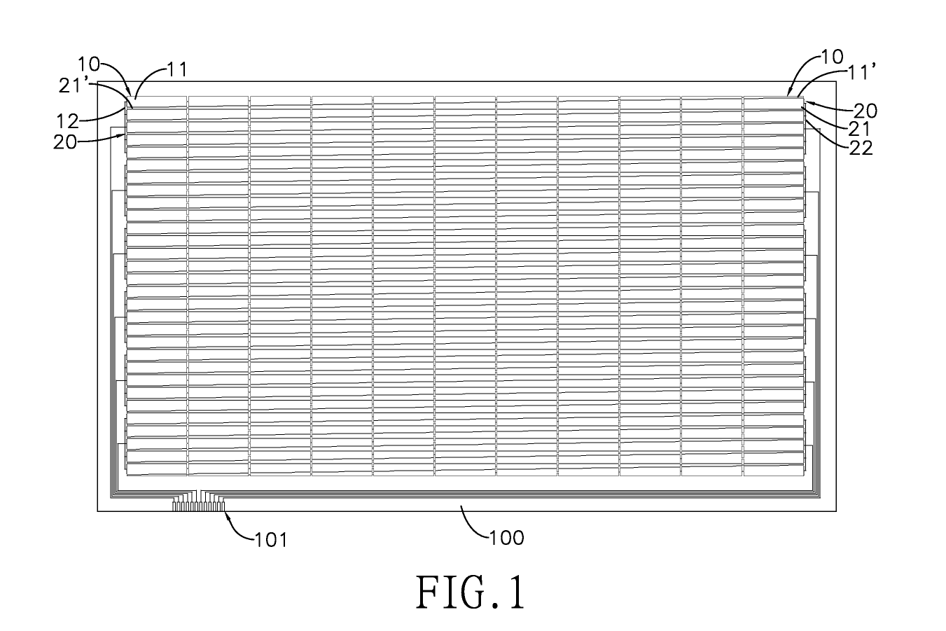

With reference to FIG. 1, a projected capacitive touch panel in accordance with the present invention has a substrate 100, multiple first electrode strings 10, multiple second electrode strings 20 and a set of connection pads 101. The first electrode strings 10 and the second electrode strings 20 are formed on one surface of the substrate 1. The set of connection pads 101 is mounted on one side of the substrate 100 and is connected to an external controller.

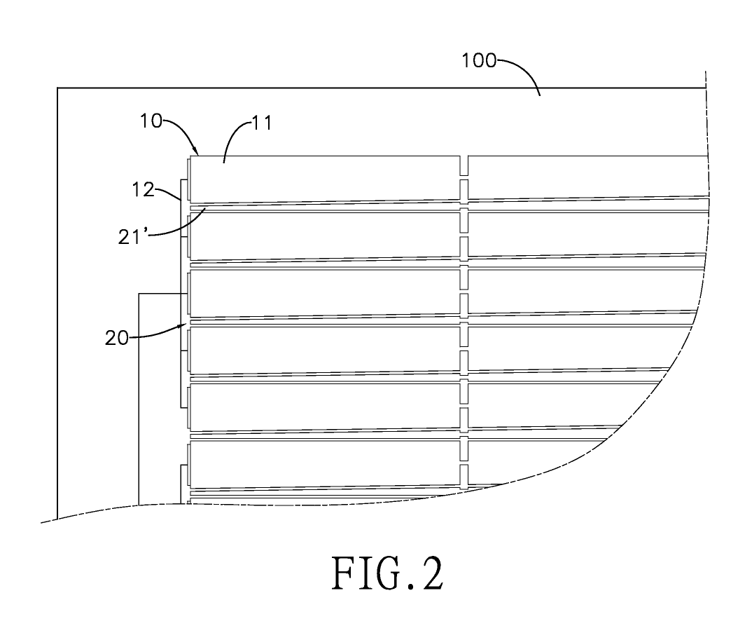

The first electrode strings 10 are parallelly formed on a surface of the substrate 100. In the present embodiment, the first electrode strings 10 are parallelly aligned in a horizontal direction and each first electrode string 10 has multiple first sensing electrodes 11, 11′ connected in series with one another. Each first sensing electrode 11, 11′ is elongated and slender and a width of the first sensing electrode 11, 11′ is greater than a height thereof Each first electrode string 10 has a first end and a second end. In the present embodiment, the first end and second end respectively indicate the left side and the right side on the figures. With reference to FIG. 2, each first electrode string 10 has a first leading wire 12. One end of the first leading wire 12 is connected to the first end of the first electrode string 10. The first electrode strings are evenly divided into groups. The first electrode strings 10 in each group are adjacent to one another. The other ends of the first leading wires 12 of the first electrode strings 10 in each group are commonly connected to one of the set of connection pads 101.

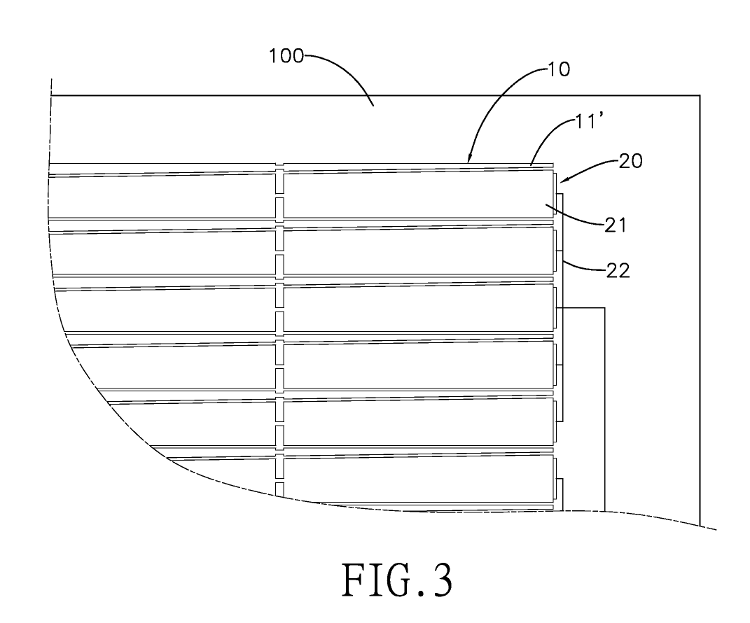

The first sensing electrodes 11, 11′ progressive decrease in area from the first end to the second end. The first sensing electrode 11 on the first end of each first electrode string 10 has the largest area. With reference to FIG. 3, the first sensing electrode 11 on the second end of each first electrode string 10 has the smallest area. In the present embodiment, the way of progressively decreasing the areas of the first sensing electrodes 11, 11′ is to keep the widths of the first sensing electrodes 11, 11′ intact and progressively decrease the heights thereof from the first end to the second end of each first electrode string 10. Hence, the first sensing electrodes 11, 11′ of the first electrode strings 10 directly align with one another in a vertical direction.

The second electrode strings 20 are parallelly formed on the surface of the substrate 100 in the horizontal direction. The first electrode strings 10 and the second electrode strings 20 are alternately arranged on the substrate 100 in the vertical direction. Each second electrode string 20 has multiple second sensing electrodes 21, 21′ connected in series with one another. Each second sensing electrode 21, 21′ is elongated and slender and a width of the second sensing electrode 21, 21′ is greater than a height thereof Each second sensing electrode 21, 21′ has a first end and a second end. The first end and the second end still respectively indicate the left side and the right side on the figures. Each second electrode string 20 has a second leading wire 22. One end of the second leading wire 22 is connected to the first end of the second electrode string 20. The second electrode strings 20 are evenly divided into groups. The second electrode strings 20 in each group are adjacent to one another. The other ends of the second leading wires 22 of the second electrode strings 20 in each group are commonly connected to another one of the set of connection pads 101.

The second sensing electrodes 21, 21′ progressive decrease in area from the second end to the first end. The second sensing electrode 21′ on the first end of each second electrode string 20 has the smallest area while the second sensing electrode 21 on the second end of each second electrode string 20 has the largest area. In the present embodiment, the way of progressively decreasing the areas of the second sensing electrodes 21, 21′ is to keep the widths of the second sensing electrodes 21, 21′ intact and progressively decrease the heights thereof from the second end to the first end of each second electrode string 20. Hence, the second sensing electrodes 21, 21′ of the second electrode strings 20 directly align with one another in the vertical direction. In other words, the first sensing electrodes 11′, 11 and the second sensing electrodes 21, 21′ are arranged in the form of a matrix.

From the foregoing, the first sensing electrodes 11, 11′ of the first electrode strings 10 are vertically aligned with the respective second sensing electrodes 21, 21′ of the second electrode strings 20. Each first sensing electrode 11, 11′ and adjacent one of the second sensing electrodes 21′, 21 constitute a coupling capacitor therebetween. Every several first electrode strings 10 and every several second electrode strings 20 are commonly connected through the respective first leading wire 12 and second leading wire 22. A coupling capacitor is formed between each first sensing electrode 11, 11′ of the commonly connected first electrode strings 10 and adjacent one of the second sensing electrodes 21′, 21 of the commonly connected second electrode strings 20 and the entire coupling capacitors are parallelly connected to result in a relatively higher capacitance value and faster touch response time. As the first sensing electrodes 11, 11′ of the first electrode strings 10 and the second sensing electrodes 21, 21′ of the second electrode string 20 progressively decrease in area from the first end to the second end, the first sensing electrodes 11 of the first electrode strings 10 and the second sensing electrodes 21 of the second electrode strings 20 adjacent to the corresponding commonly connected first leading wires 12 and second leading wires 22 are the largest in area. Because of the parallel connection of the coupling capacitors, the coupling capacitance value between the adjacent first sensing electrode 11, 11′ and second sensing electrodes 21′, 21 near the left and right sides of the substrate 100 increases and the touch response time is also accelerated.

When reading data, the controller connected to the set of connection pads 101 considers that the first electrode strings 10 and the second electrode strings 20 are respectively aligned in the directions of X axis and Y axis. If a touch event takes place on the right side of the substrate 100, a Y-axis coordinate is determined by directly reading a capacitance variation (large coupling capacitance occurring at the touched position) of the second electrode strings 20 in the Y-axis direction and an X-axis coordinate is determined by scanning the commonly connected first leading wires 12 of the first electrode strings 10. If a touch event takes place on the left side of the substrate 100, an X-axis coordinate is determined by directly reading a capacitance variation of the first electrode strings 10 in the X-axis direction and a Y-axis coordinate is determined by scanning the commonly connected second leasing wires 22 of the second electrode strings 10.

When the first electrode strings 10 and the second electrode strings 20 are so implemented that every adjacent five of the first electrode strings and every adjacent five of the second electrode strings in the proximity of the first end and the second end are commonly connected to constitute multiple sensing areas.

Each sensing area contains 5 first sensing electrodes 11 or 5 second sensing electrodes 21 and is smaller than the size of a finger tip, for example smaller than 8 mm².

The present invention is effective in not only using the foregoing technique to speed up the touch response time but also adjusting impedance.

As each first electrode string 10 or each second electrode string 20 has multiple first sensing electrodes 11, 11′ or multiple second sensing electrodes 21, 21′, the more the number of the first sensing electrodes 11, 11′ or the second sensing electrodes 21, 21′ connected in series with one another is, the more the number of impedances (first and second sensing electrodes have internal impedance) connected in series is. Hence, the first sensing electrodes 11, 11′ and the second sensing electrodes 21, 21′ at the tail ends of the first electrode strings 10 and the second electrode strings 20 have relatively higher impedance. The elongated and slender form allows to reduce the number of the first sensing electrodes 11, 11′ and the second sensing electrodes 21, 21′ when the first sensing electrodes 11, 11′ and the second sensing electrodes 21, 21′ are connected in series without compromising the goal of lowering the impedance of the first sensing electrodes 11, 11′ and the second sensing electrodes 21, 21′. Based on that the impedances of the first sensing electrodes 11, 11′ and the second sensing electrodes 21, 21′are proportional to the size thereof, the first sensing electrodes 11, 11′ on the first electrode strings 10 and the second sensing electrodes 21, 21′ on the second electrode strings 20 progressively decrease in area along opposite directions, so that the impedances of the first sensing electrodes 11, 11′ on the first electrode strings 10 and the second sensing electrodes 21, 21′ on the second electrode strings 20 can be adjusted. Meanwhile, each progressively decreasing first sensing electrode 11, 11′ is adjacent to one of the progressively increasing second sensing electrodes 21, 21′ in area along opposite directions, and substantially, the first sensing electrodes 11, 11′ with the maximum area and the minimum area on the first end and the second end (edges of the touch panel) are adjacent to the corresponding second sensing electrodes 21′, 21 with the minimum area and the maximum area. The differences of RC value between the adjacent first sensing electrodes 11, 11′ and second sensing electrodes 21′, 21 on the first end and the second end of the substrate 100 appear to be the largest. Touch events on both ends of the touch panel can be easily detected due to the significant difference of RC value. A calibration for impedance adjustment can be easily performed, the accuracy of touch detection on edges of the touch panel can be enhanced in favor of the manufacture of oversized projected capacitive touch panels.

Moreover, as the first sensing electrodes 11, 11′ of the first electrode strings 10 and the second sensing electrodes 21, 21′ of the second electrode strings 20 are arranged in the form of a matrix and are parallelly and alternately aligned, it is impossible for the first electrode strings 10 and the second electrode strings 20 to intersect. Since there are no intersections between the first electrode strings 10 and the second electrode strings 20, the process of forming a separation layer can be removed from the entire manufacturing processes, thereby simplifying the manufacturing processes.

Even though numerous characteristics and advantages of the present invention have been set forth in the foregoing description, together with details of the structure and function of the invention, the disclosure is illustrative only.

Changes may be made in detail, especially in matters of shape, size, and arrangement of parts within the principles of the invention to the full extent indicated by the broad general meaning of the terms in which the appended claims are expressed.

What is claimed is:

1. A projected capacitive touch panel with accelerated touch response time comprising:
a substrate having a surface;
multiple first electrode strings parallelly formed on the surface of the substrate, each first electrode string having multiple first sensing electrodes connected in series with one another and having a first end and a second end, wherein the first sensing electrodes are elongated and slender and progressive decrease in area from the first end to the second end, the first electrode strings are divided into groups, the first electrode strings in each group are adjacent to one another, and the first ends of the first electrode strings in each group are commonly connected; and
multiple second electrode strings parallelly formed on the surface of the substrate, each second electrode string having multiple second sensing electrodes connected in series with one another and having a first end and a second end, wherein the first electrode strings and the second electrode strings are elongated and slender and are alternately arranged on the substrate, the second sensing electrodes progressive decrease in area from the second end to the first end, and the second electrode strings are evenly divided into groups, the second electrode strings in each group are adjacent to one another, and the second ends of the second electrode strings in each group are commonly connected.

2. The projected capacitive touch panel as claimed in claim 1, wherein
the substrate has a set of connection pads mounted on one side of the substrate;
each first electrode string has a first leading wire, wherein one end of each first leading wire is connected to the first end of a corresponding first electrode string, and the other ends of the first leading wires of the first electrode strings in each group are commonly connected to one of the set of connection pads; and
each second electrode string has a second leading wire, wherein one end of each second leading wire is connected to the second end of a corresponding second electrode string, and the other ends of the second leading wires of the second electrode strings in each group are commonly connected to another one of the set of connection pads.

3. The projected capacitive touch panel as claimed in claim 2, wherein
a width of each first sensing electrode is greater than a height thereof; and
a width of each second sensing electrode is greater than a height thereof.

4. The projected capacitive touch panel as claimed in claim 3, wherein
the first sensing electrodes remain intact in width and progressively decrease in height from the first end to the second end of a corresponding first electrode string; and
the second sensing electrodes remain intact in width and progressively decrease in height from the second end to the first end of a corresponding second electrode string.
